(19) United States
(12) Patent Application Publication
(10) Pub. No.: US 2013/0033860 A1
(43) Pub. Date: Feb. 7, 2013

(54) High Efficiency Grid Troffer

(71) Applicant: Zengyao Tong, Ningbo (CN)

(72) Inventor: Zengyao Tong, Ningbo (CN)

(73) Assignee: NINGBO BOTONG LIGHTING TECHNOLOGY CO, LTD., Ningbo (CN)

(21) Appl. No.: 13/528,091

(22) Filed: Jun. 20, 2012

(30) Foreign Application Priority Data
Aug. 1, 2011 (CN) 201120276140.3

(51) Int. Cl. F21V 7/04

(52) U.S. Cl. 362/225

(57) ABSTRACT

A high efficiency grid troffer comprises a housing, a grid door cover, and one or more pairs of multifaceted reflector and light emitting unit. The multifaceted reflectors are attached inside the housing. Each multifaceted reflector contains a predetermined number of concave or convex facets. Each facet can be of various shapes and sizes to achieve maximum lighting efficiency and even distribution of light. A light emitting unit is paired with each multifaceted reflector and is also attached to the housing. The grid door cover is attached to the housing to close the high efficiency grid troffer. The grid door cover can be removed from the housing for easy assembly and maintenance.

### CROSS-REFERENCE TO RELATED APPLICATION

The present invention claims priority from a Chinese Patent Application No. 201120276140.3 to Zengyao Tong of Ningbo Botong Lighting Technology Co., filed on Aug. 1, 2011, and titled “High Efficiency Grid Troffer”, which is hereby incorporated in its entirety by reference.

### BACKGROUND

### Prior Art

Troffers are widely used for lighting in office and industrial buildings due to their easy installation, simple maintenance, and low cost. The troffers on the market now include single-tube troffers and multiple-tube troffers. The light tube used with these troffers may be T5, T8 or T12. In many cases, these troffers use an oxidized aluminum plate as a reflective surface on the back of the light tube. The aluminum reflective plates are simply structured. They are not lighting efficient and a good percentage of light is wasted. When a large amount of light is required for a space, the common method is to increase the wattage of the light tube, or to reduce the distance between adjacent troffers. Both options increase material and energy costs.

Some previous efforts have been made to increase the lighting efficiency of the reflector installed in lamps or troffers. U.S. Pat. No. 4,651,260 describes a reflector system for high intensity discharge lamps, which are generally applied to outdoor environments. U.S. Pat. No. 5,483,430 illustrates a multi-faceted reflector to obtain a desirable aggregate light distribution for exterior automotive lighting applications, where a point light source is used. Each facet consists of three discrete reflecting areas, forming a concave structure to optimize the light output. The reflectors in these previous inventions are not adaptable to the indoor fluorescent lighting systems. U.S. Pat. No. 4,907,143 discloses a compact 2×2 troffer that utilizes an upper reflector system containing four reflective portions and conventional louvers to improve light distribution and to control glare. U.S. Pat. No. 5,394,317 describes a lamp reflector having a pre-formed member with a smooth and continuously curved shape to increase the optical efficiency of a fluorescent lamp in a fixture. Those reflectors or troffers in the lighting systems focus on the design improvements at a macro scale. In these systems, the ratio of the side or diagonal length of the facet to the diameter of the light tube is significantly greater than 1 based on the descriptions in these previous patents. However, the present invention discloses a reflector system containing multiple facets with such a ratio significantly smaller than 1. Such microscopic facets allow more control of light distribution. The design in the present invention has several advantages over those prior inventions. It is more energy efficient by reflecting more light to the desired area and by distributing the light more uniformly; it provides longer life for the troffer and lighting elements in the system by effectively keeping the temperature inside the troffer lower; and it has lower cost due to the relatively simple manufacturing process.

### SUMMARY OF INVENTION

The present invention provides a high efficiency grid troffer to overcome the shortcomings of the existing troffers on the market. In accordance with one embodiment, it comprises a housing, a grid cover, and one or more pairs of multifaceted reflector and light emitting unit. The multifaceted reflectors and the light emitting units are positioned at predetermined locations inside the housing to enable more efficient and uniform distribution of light.

The multifaceted reflector is made of a base layer with predetermined facets. These facets are either concave or convex and have predetermined sizes and shapes depending on lighting requirements. The shapes of the facets can be circle, oval, triangle, square, rectangle, polygon, round-polygon, etc. Each facet has a continuous surface. This base layer can be made of plastic, metal, or other material, and is coated, electroplated, or in other methods bonded with a reflective film.

The said multifaceted reflector is mounted inside the housing. Each multifaceted reflector is coupled with a light emitting unit which is also mounted inside the housing. The multifaceted reflector is placed above the light emitting unit to reflect the light from the light emitting unit. The light emitting unit comprises a fluorescent light tube or similar light source, a ballast or current stabilizer, and two sockets, all connected with electric wires. The multifaceted reflector has two aligned openings to enable the light tube to plug into the two sockets.

The grid door cover includes at least one open grid section and one covered section. The open grid section is under the light source to allow maximum light passing through. The covered section conceals electric wires, ballast, and mounting materials, and is next to the open grid section. When the high efficiency grid troffer has multiple light emitting units, the grid door cover will have multiple open grid sections and covered sections. Therefore, the grid door cover will always encloses the troffer regardless of the number of light emitting units in the troffer. The grid door cover is attached to the housing through an opening and closing device for easy assembly and maintenance.

The present invention enables the light emitting unit to distribute the light more efficiently and evenly, which considerably reduces material and energy costs. This high efficiency grid troffer can be used in offices, schools, factories, and other similar facilities.

### BRIEF DESCRIPTION OF DRAWINGS

For a more complete understanding of the present invention, reference is now made to the following descriptions taken in conjunction with the following drawing, wherein:

FIG. 1 is a bottom view of an embodiment of a high efficiency grid troffer in accordance with the present invention

FIG. 2 is an exploded view of the high efficiency grid troffer in FIG. 1

FIG. 3 is an enlarged view of section A of FIG. 1

FIG. 4 is a sectional view taken along line B-B of FIG. 1

FIG. 5 is an enlarged view of section D of FIG. 4

FIG. 6 is a sectional view taken along line C-C of FIG. 1

FIG. 7 is an enlarged view of section E of FIG. 6

FIG. 8 is a bottom view of a multifaceted reflector in accordance with the present invention

FIG. 9 is a sectional view taken along line F-F of FIG. 8

FIG. 10 is a sectional view taken along line H-H of FIG. 8

### DRAWINGS

### Reference Numerals

1 High efficiency grid troffer

11 Housing

111 Opening and closing device

12 Grid door cover

121 Open grid section

122 Closed section

13 Multifaceted reflector

131 Facet

14 Light emitting unit

141 Light source

142 Ballast

143 Socket

### DETAILED DESCRIPTION OF INVENTION

### One Embodiment

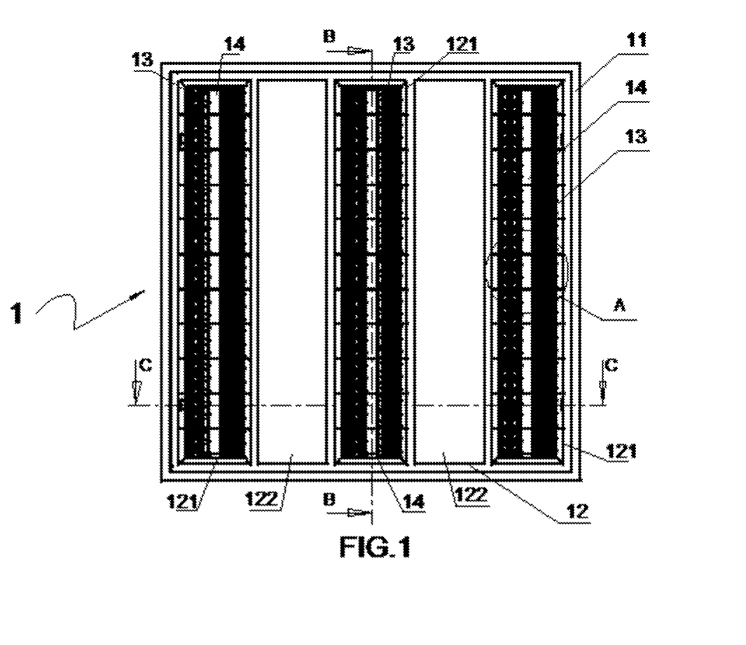

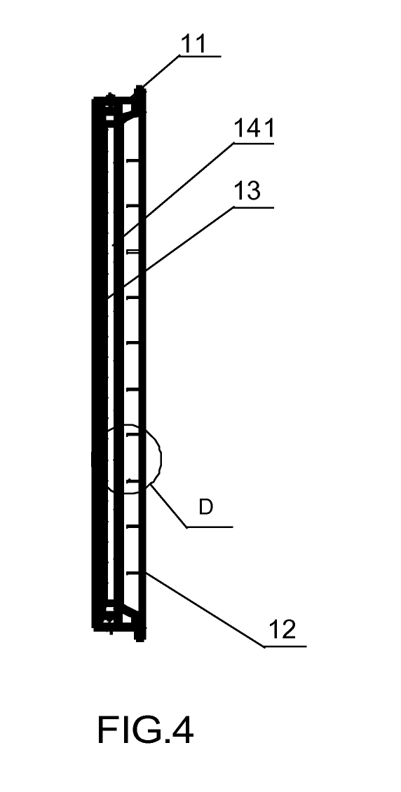

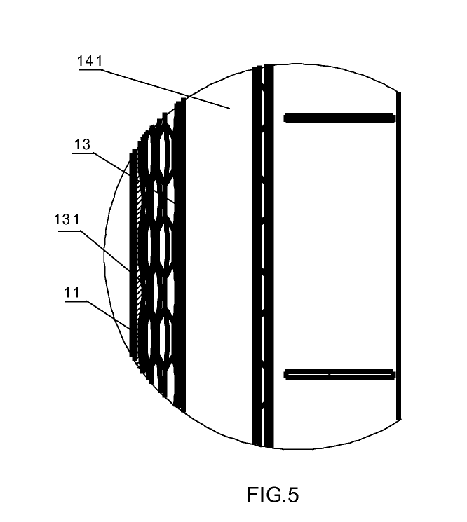

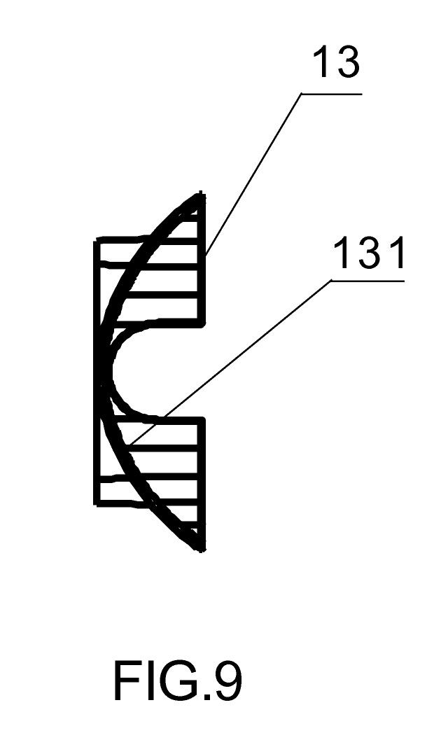

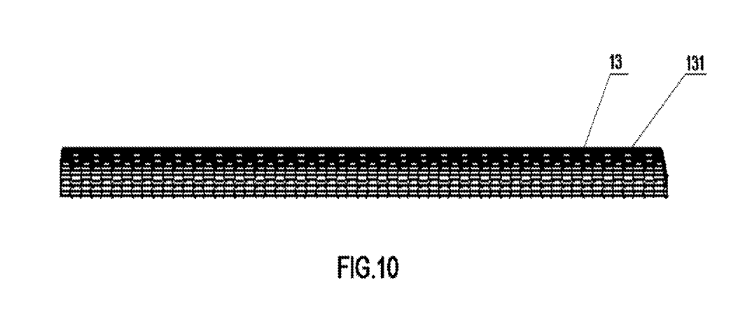

### FIGS. 1-10

While the present invention is disclosed with reference to the embodiment described herein, it should be clear that the present invention should not be limited to such embodiment. Therefore, the description of the embodiment herein is only illustrative of the present invention and should not limit the scope of the invention as claimed.

Referring initially to FIG. 1, the present invention provides a high efficiency grid troffer 1. One embodiment of this invention comprises a housing 11, a grid door cover 12, and one or more pairs of multifaceted reflector 13 and light emitting unit 14. Every pair of multifaceted reflector 13 and light emitting unit 14 is mounted inside the housing 11. The multifaceted reflector 13 is coupled with the light emitting unit 14 in each pair. The grid door cover 12 enclosed the multifaceted reflector 13 and the light emitting unit 14 inside the housing 11, as well as electric wires and mounting materials, to seal the high efficiency grid troffer 1.

FIG. 1 shows the bottom view of one embodiment of the high efficiency grid troffer 1 in accordance with the present invention. The high efficiency grid troffer 1 comprises a housing 11, a grid door cover 12, and three pairs of the multifaceted reflector 13 and the light emitting unit 14, which are distanced evenly in the housing 11. The multifaceted reflector 13 and the light emitting unit 14 are mounted inside the housing 11. The grid door cover 12 contains open grid sections 121 which allow light to go through freely, and covered sections 122 which conceal electric wires, the ballast, and mounting materials.

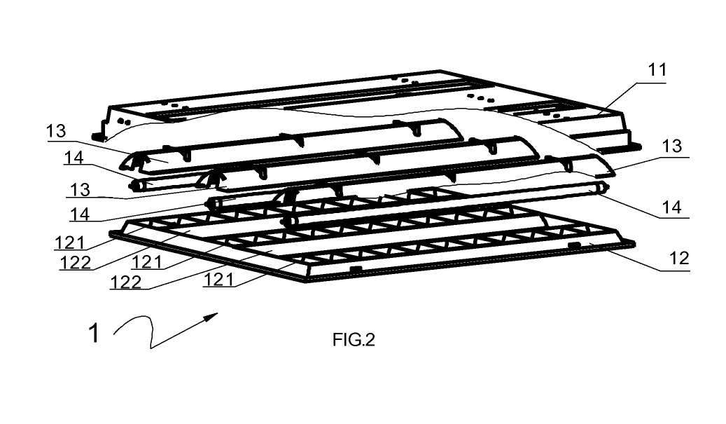

FIG. 2 gives an exploded view of the high efficiency grid troffer 1 in FIG. 1. Each multifaceted reflector 13 is placed in a predetermined position to the light emitting unit 14 to reflect the light from the light emitting unit 14. The housing 11 is partially removed to better illustrate the relationships among parts.

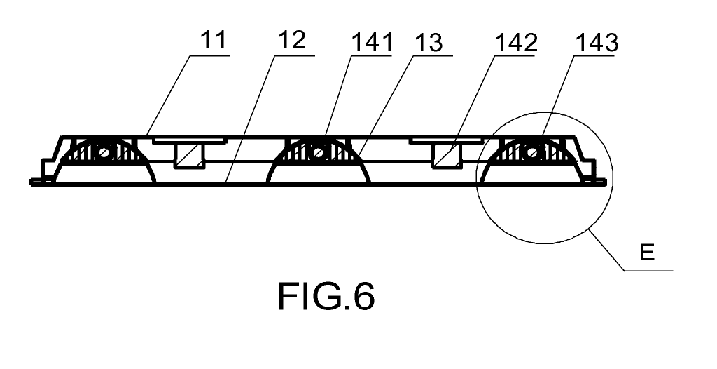

FIG. 6 shows the details of the light emitting unit 14. Each light emitting unit 14 consists of a light source 141 such as a fluorescent light tube, a ballast or current stabilizer 142, and two sockets 143. The sockets 143 are mounted at the two ends of the housing 11, aligned with the openings of the multifaceted reflector 13. The light source 141 rests on the sockets 143. The ballast 142 is mounted on the bottom of the housing 11.

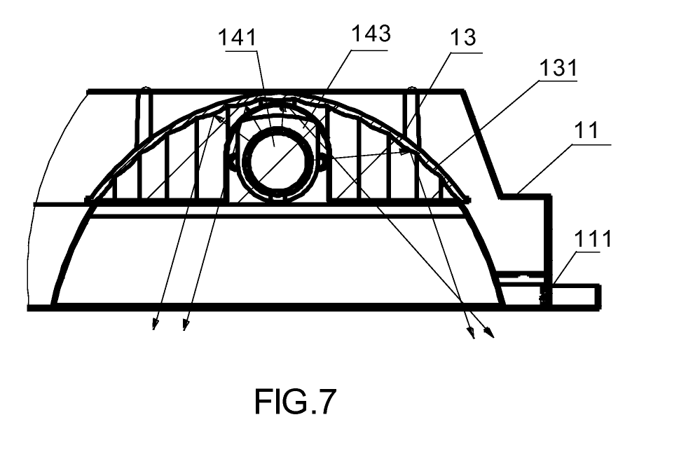

FIG. 7 shows the details of the multifaceted reflector 13. The multifaceted reflector 13 consists of a base layer with a reflective coat. The base layer can be made of plastic, metal or other material. The reflective coat can be achieved by vacuum plating, chrome electroplating, or other means. The reflecting surface consists of many small concave or convex facets 131. The multifaceted reflector 13 has an opening at each end to let the light source 141 pass through.

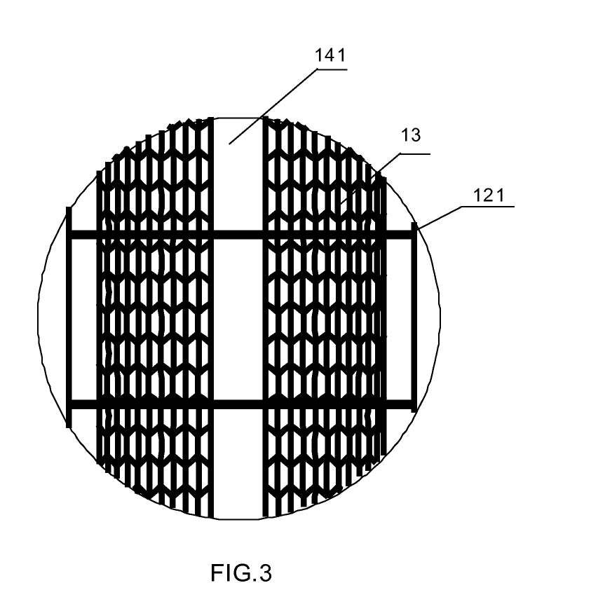

The relationship between the multifaceted reflector 13 and the light source 141 can also be explained in FIGS. 3, 4, and 5. The reflecting surface of the multifaceted reflector 13 faces the light source 141 and is above the light source 141 to reflect the light to the desired region. The facet 131 on the multifaceted reflector 13 may be concave and convex. It may be in the shape of a circle, oval, triangle, square, rectangle, polygon, round-corner polygon, diamond, cone, tapered cylinder, or other generally used geometric shapes. The facet 131 may have various sizes to meet predetermined design goals.

The size, shape, concavity, and convexity of facet 131 are determined by the illumination requirements. The size of facet 131 can be very small. The side, edge, or diameter of the facet 131 ranges from 0.5 cm to 5 cm. Given a specification of a region and its illumination requirements, we can determine the size, shape, concavity, and convexity of facet 131. Such flexibility in the design of the facet 131 provides many benefits compared with prior art troffers. First, it allows the maximum amount of light from the light source 141 to be reflected toward a predetermined region. Second, it allows the light to be distributed evenly across the predetermined region. Third, it provides finer control of light reflection.

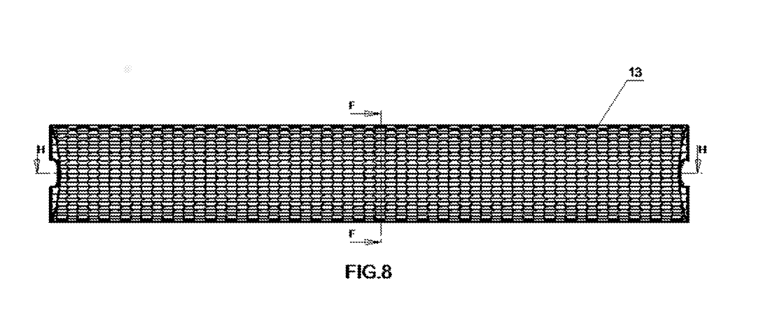

FIGS. 8-10 show the details of the multifaceted reflector 13. The multifaceted reflector 13 is a parabolic enclosure with a main section and two end panels, one at each end. The end panel has a semi-circle opening to let the light source 141 (not shown in FIGS. 8-10) pass through. The multifaceted reflector 13 consists of many small facets 131, uniformly distributed along the main section and the two end panels.

As shown in FIG. 2, the grid door cover 12 encloses the high efficiency grid troffer 1. The grid door cover 12 is attached to the housing 11 through an opening and closing device 111 on the housing 11. The opening and closing device 111 may be spring tabs or other attachment means. The grid door cover 12 can be easily installed or removed for maintenance purposes by the opening and closing device 111.

It is obvious the high efficiency grid troffer 1 can have one or more pairs of the multifaceted reflector 13 and light emitting unit 14. One embodiment is described here with three pairs of the multifaceted reflector 13 and light emitting unit 14. Other common embodiments may include one, two, or four pairs of the multifaceted reflector 13 and light emitting unit 14.

The multifaceted reflector 13 in the high efficiency grid troffer 1 can maximize the lighting efficiency. It also distributes the light more uniformly, thus reduces the breakdown of the surrounding material caused by the high concentrated heat from the light.

In summary, one can see that, according to one embodiment of the invention, the present invention provides a high efficiency grid troffer.

While the above description contains much specificity, these should not be construed as limitations on the scope of any embodiment, but as exemplifications of various embodiments thereof. Thus the scope should be determined by the appended claims and their legal equivalents, and not by the illustrations given.

This invention claims:

1. A high efficiency grid troffer for maximizing the amount of light being reflected, comprising:
a housing,
a grid attached to the housing,
one or more multifaceted reflectors attached to the inside of the said housing, and
one or more light emitting units located in the inside of said housing and fixed in
predetermined positions in relation to said multifaceted reflectors,
whereby said high efficiency grid troffer will utilize electric energy efficiently and distribute light in accordance with predetermined lighting requirements, so that the energy is saved and the life span of said high efficiency grid troffer is extended.

2. The system of claim 1, wherein said multifaceted reflectors have a base layer coated with a high reflective film.

3. The multifaceted reflectors of claim 2, wherein said reflectors have a surface of multiple concave or convex facets.

4. The multifaceted reflectors of claim 3, wherein said facets have a predetermined size in accordance with lighting requirements.

5. The multifaceted reflectors of claim 3, wherein said facets have a predetermined shape in accordance with lighting requirements.

6. The multifaceted reflectors of claim 3, wherein said facets have a predetermined base shapes in accordance with lighting requirements.

7. The multifaceted reflectors of claim 2, wherein said base layer is made entirely or in part of plastic, metal, or other material.

8. The system of claim 1, wherein said light emitting unit comprises a light emitting device, a ballast, and two sockets so that said light emitting device can be fixed in said housing beneath said multifaceted reflectors.

9. The system of claim 1, wherein said system can be multiplied and seamlessly assembled together.

10. A troffer system, comprising:
a housing,
a grid attached to the housing,
one or more reflectors with concave or convex facets attached to the inside of the housing, and
one or more light emitting units located in the inside of the housing and fixed in predetermined positions in relation to said reflectors,
whereby said troffer will utilize electric energy and distribute light in accordance with predetermined lighting requirements, so that the energy is maximized and the life span of said troffer is extended.

11. The system of claim 10, wherein said reflectors have a base layer coated with a high reflective film.

12. The system of claim 10, wherein said facets have a predetermined size and shape in accordance with illuminating requirements.
